(19) United States
(12) Patent Application Publication
(10) Pub. No.: US 2018/0265367 A1
(43) Pub. Date: Sep. 20, 2018

(54) METHODS OF HYDROGENATING A HALOSILANE

(71) Applicant: Hemlock Semiconductor Operations LLC, Hemlock, MI (US)

(72) Inventors: Shaun Gregory Kleiber, Freeland, MI (US); Susan M. Rhodes, Concord, OH (US)

(21) Appl. No.: 15/537,574

(22) PCT Filed: Dec. 16, 2015
(86) PCT No.: PCT/US2015/065959

§ 371 Date: Jun. 19, 2017

Related U.S. Application Data
(60) Provisional application No. 62/093,521, filed on Dec. 18, 2014.

(51) Int. Cl. C01B 33/107; B01J 23/72; B01J 23/755; B01J 23/89

(52) U.S. Cl. CPC C01B 33/10773; C01B 33/1071; B01J 23/8926; B01J 23/755; B01J 23/72

(57) ABSTRACT

A method of hydrogenating a halosilane comprises: contacting a halosilane having the formula HaSiX(4-a), wherein a has a value of 0 to 4, and each X is independently a halogen atom and wherein if a is 0, the halosilane further comprises a hydrogen source, with a catalyst composition comprising at least two different metals, wherein the at least two different metals are selected from Cu and one of Co, Fe, Ni, and Pd; wherein the ratio of Cu to the second metal in the catalyst composition is 90:10 to 10:90; wherein the contacting is conducted at a temperature sufficient to hydrogenate a halosilane; and wherein an increase in the amount of halosilane hydrogenated is observed as compared to a method with a catalyst composition comprising one metal at the same overall loading of metal in the catalyst composition.

Various halosilanes find use in different industries. Trihalosilanes, such as trichlorosilane (HSiCl₃), are useful as reactants in chemical vapor deposition (CVD) processes for making high purity polycrystalline silicon, are usually used in solar cells (solar grade polysilicon) and/or electronic chips (semiconductor grade polysilicon), but have other applications as well. Alternatively, trihalosilanes can be hydrolyzed in known processes to produce a polysiloxane, such as a resin.

Methods of preparing halogenated silanes, such as trihalosilanes, are known in the art. Typically, halogenated silanes are produced commercially by the Mueller-Rochow Direct Process, which comprises passing a hydrogen halide over zero-valent silicon (Si⁰) in the presence of a copper catalyst and various optional promoters. Mixtures of halosilanes are produced by the Direct Process.

The typical process for making the Si⁰ used in the Direct Process consists of the carbothermic reduction of SiO₂ in an electric arc furnace. Extremely high temperatures are required to reduce the SiO₂, so the process is energy intensive. Consequently, production of Si⁰ adds costs to the Direct Process for producing silanes. Therefore, there is a need for a more economical method of producing silanes that avoids or reduces the need of using Si⁰ .

A number of methods of producing trihalosilanes have been disclosed in addition to the Direct Process described above. Trichlorosilane (HSiCl₃) has been produced by passing silicon tetrachloride (SiCl₄), H₂, and/or HCl over Si⁰ , with or without other catalysts, at temperatures of at least 250° C.

While the art describes methods of producing trichlorosilane, these methods have some limitations. Many of these processes employ Si⁰. Since Si⁰ is typically produced by the highly energy-intensive carbothermic reduction of silicon dioxide, using Si⁰ adds costs to these processes. Other methods require multiple processing steps with repeated catalyst regeneration steps necessitated by decreasing yield or selectivity of the method to form the desired trihalosilane. Therefore, there is a need for more economical and simpler methods of producing trihalosilanes that avoid or reduce the need for using Si⁰ , have fewer process steps, and/or that have more uniform yield and/or selectivity for hydridosilanes.

A method of hydrogenating a halosilane comprises: contacting a halosilane having the formula HaSiX(4-a), wherein a has a value of 0 to 3, and each X is independently a halogen atom and wherein if a is 0, the halosilane further comprises a hydrogen source, with a catalyst composition comprising at least two different metals, wherein the at least two different metals are selected from Cu and one of Co, Fe, Ni, and Pd; wherein the ratio of Cu to the second metal in the catalyst composition is 90:10 to 10:90; wherein the contacting is conducted at a temperature sufficient to hydrogenate a halosilane; and wherein an increase in the amount of halosilane hydrogenated is observed as compared to a method with a catalyst composition comprising one metal at the same overall loading of metal in the catalyst composition.

A method of hydrogenating silicon tetrachloride comprises: contacting silicon tetrachloride with a catalyst composition comprising at least two different metals selected from Cu, Co, Fe, Ni, and Pd; wherein the ratio of the two metals is 75:25 to 25:75; wherein the contacting is conducted at a temperature sufficient to hydrogenate the silicon tetrachloride; and wherein an increase in the amount of silicon tetrachloride hydrogenated is observed as compared to a method with a catalyst composition comprising one metal at the same overall loading of metal in the catalyst composition.

The following is a brief description of the drawings wherein like elements are numbered alike and which are exemplary of the various embodiments described herein.

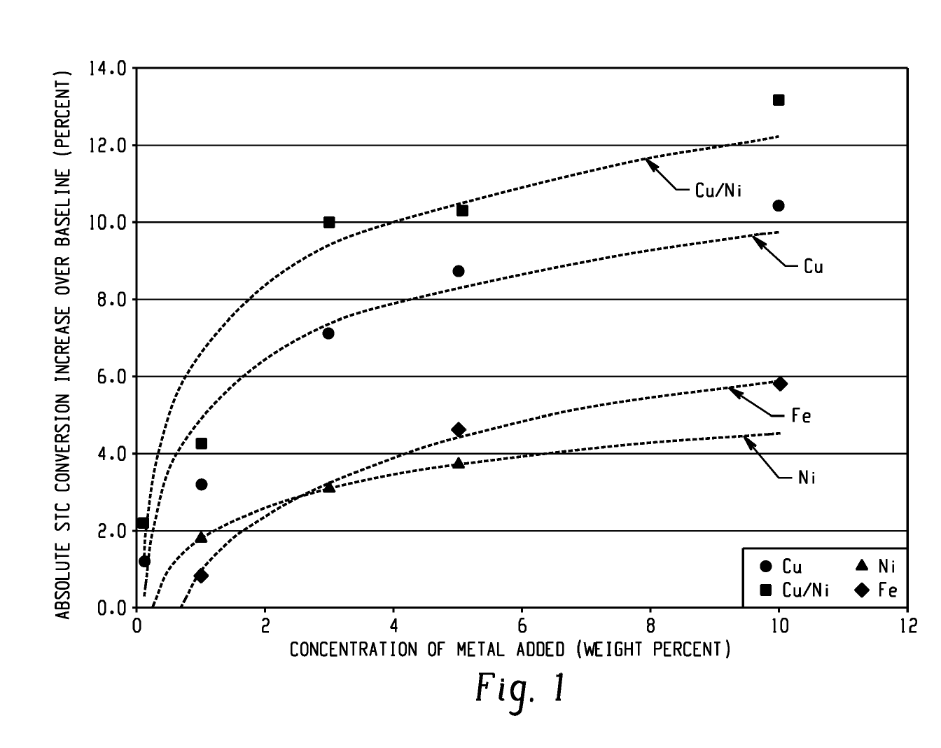

FIG. 1 is a graphical representation of the absolute silicon tetrachloride conversion increase over the baseline conversion versus the concentration of metal added for various metals tested.

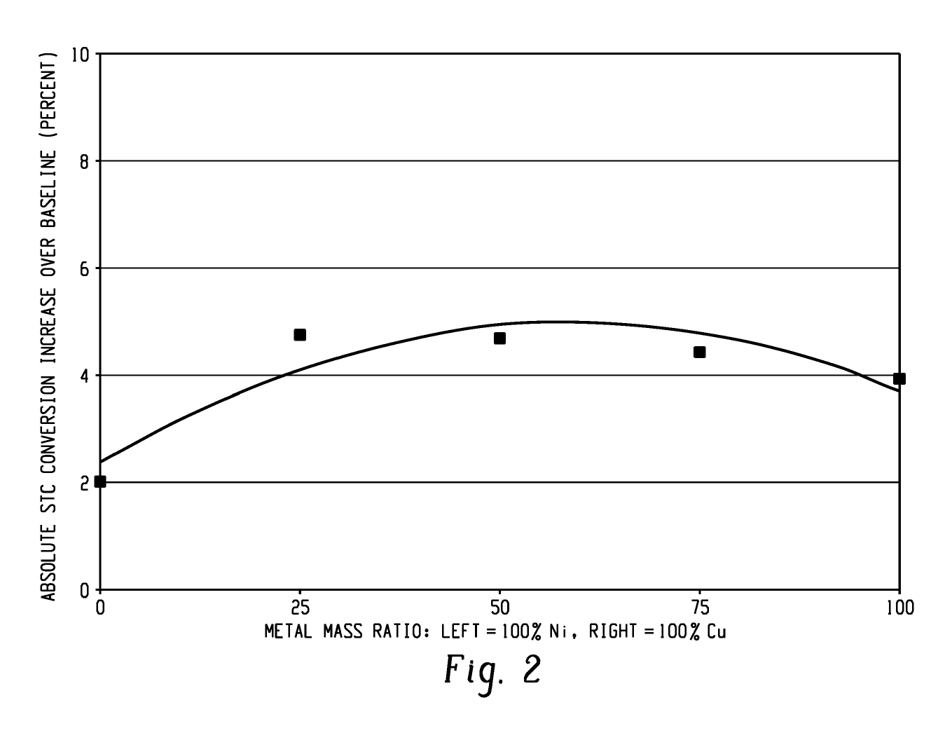

FIG. 2 is a graphical representation of the absolute silicon tetrachloride conversion increase over the baseline conversion versus the ratio of various metals added at a total metal concentration of 1 wt %.

Metallurgical grade silicon (MG—Si) generally contains about 99% silicon and about 1% other elements, which are present as impurities. The presence of impurities in metallurgical grade silicon can affect the conversion of the metallurgical grade silicon to production grade silicon, e.g., solar grade silicon or semi-conductor grade silicon. In other words, the presence of impurities can limit the amount of solar grade silicon or semi-conductor grade silicon that can be produced from a certain amount of metallurgical grade silicon. The solar grade silicon or semi-conductor grade silicon can be produced from the conversion of metallurgical grade silicon in several steps, including the step of hydrogenation of a halosilane. Semi-conductor grade silicon generally has increased purity as compared to solar grade silicon. Contacting the halosilane with a catalyst composition comprising at least two different metals as described herein, can increase the amount of halosilane hydrogenated as compared to a method with a catalyst composition comprising only one metal at the same overall loading of metal in the catalyst composition. Increasing the amount of halosilane hydrogenation can increase the amount of production grade silicon produced from the metallurgical grade silicon.

Copper and nickel can generally be found in metallurgical grade silicon in amounts of about 30 to 50 parts per million (ppm). Small changes to these amounts do not generally affect the hydrogenation of a halosilane, for example, the hydrogenation of silicon tetrachloride to trichlorosilane in a reactor. Catalysts such as copper, nickel, or iron can be used in the hydrogenation of a halosilane. Iron can generally be present in the metallurgical grade silicon in an amount of 0.4% and can accumulate in the reactor, depending on the design of the reactor. Iron can be used to catalyze the hydrogenation of a halosilane, but it has been found to have a limit on its effectiveness. For example, even using 10% iron to hydrogenate the halosilane, for example, hydrogenation of silicone tetrachloride with a catalyst comprising 10% iron is only able to produce about 15% halogenated silicon tetrachloride, where the theoretical equilibrium is equal to 36%. Improvements in the amount of halogenated silicon tetrachloride produced are therefore, desired.

Disclosed herein are methods of hydrogenating a halosilane, for example, silicon tetrachloride. The method can include contacting the halosilane with a catalyst composition comprising at least two different metals, where the at least two different metals can be selected from copper (Cu) and at least one of cobalt (Co), iron (Fe), nickel (Ni), and palladium (Pd). The ratio of copper to the second metal in the catalyst composition can be 90:10 to 10:90. The contacting can be conducted at a temperature sufficient to hydrogenate a halosilane. With this method, an increase in the amount of halosilane hydrogenated can be observed as compared to a method with a catalyst composition comprising one metal at the same overall loading of metal in the catalyst composition.

If the hydrogen source is present, the hydrogen source can comprise H₂, while the mole ratio of the H₂ to the halosilane can be 20:1 to 1:1.

The halosilane can have the formula HₐSiX(₄₋ₐ), where subscript “a” can have an average value from 0 to less than or equal to 3, and each X can independently be a halogen atom. The halosilane can be selected from monochlorosilane, dichlorosilane, trichlorosilane, silicon tetrachloride, or a combination comprising at least one of the foregoing. For example, the halosilane can be silicon tetrachloride.

The catalyst composition can include a metal combination. The metal combination can comprise at least two different metals. The at least two different metals can be selected from: (i) copper (Cu) and nickel (Ni), (ii) Cu and palladium (Pd), (iii) Cu and iron (Fe), (iv) Cu and cobalt (Co), or (v) Cu and two or more of Co, Ni, Pd, and Fe. The amount of each metal in the metal combination can depend on various factors including the specific metals and temperature included in the contacting step. For example, when the metal combination is Cu and one other metal (e.g., Co, Fe, Ni, or Pd), the amount of Cu can be up to 90%, for example up to 80%, for example 20% to 80%, for example 75%, and for example 50% of the metal combination, with the balance being one of Co, Fe, Ni and Pd. For example, the ratio of copper to the second metal in the catalyst composition can be 90:10 to 10:90, for example, 80:20 to 20:80, for example, 75:25 to 25:75, for example 50:50. The catalyst composition can comprise copper and nickel. The catalyst composition can comprise copper and palladium.

The catalyst composition can be hydrogenated into monochlorosilane, dischlorosilane, trichlorosilane, or a combination comprising at least one of the foregoing. For example, the halosilane, for example, silicon tetrachloride, can be hydrogenated into trichlorosilane.

The exact conditions for hydrogenation can depend on the phase diagram for silicon and the at least two different metals selected, however, hydrogenation can be conducted at a temperature of 100° C. to 1,200° C., for example 500° C. to 1,000° C., for example 600° C. to 900° C., for example 650° C. to 850° C., for example 700° C. to 800° C., and for example 750° C., for a time sufficient to hydrogenate the halosilane.

Hydrogenation of a halosilane as described herein with a catalyst composition comprising at least two different metals can provide an increase in the amount of halosilane hydrogenated as compared to a catalyst system comprising one metal at the same overall loading of metal in the catalyst composition. A synergistic effect between the at least two different metals can be observed in the method of hydrogenating halosilane. Without wishing to be bound by theory, it is believed that in a catalyst composition comprising copper and nickel as disclosed herein, the solubility of silicon can increase with increasing nickel content and that copper nickel alloys can exhibit a strong tendency to absorb gases as nickel content and temperature increase. For example, a catalyst composition comprising a ratio of 75:25 copper/nickel would generally have less of a tendency to absorb gases than a catalyst composition comprising a ratio of 25:75 copper/nickel. For example, hydrogen gas solubility can increase with increasing nickel content, with up to 80% nickel present in the catalyst composition.

Performance of the catalyst disclosed herein during hydrogenation of a halosilane can decrease over time as silicon is depleted from a bed. Without wishing to be bound by theory, it is believed that the decrease comes from some loss of copper as a volatile metal chloride from the reactor and/or conversion of the catalyst to a non-catalytically active species. However, it was unexpectedly discovered that with the method and catalyst disclosed herein, hydrogenation of the halosilane, e.g., silicon tetrachloride (i.e., conversion of silicon tetrachloride to trichlorosilane) can be maintained more consistently when compared to a catalyst composition comprising only one metal, e.g., copper.

The at least two different metals can be provided in any convenient form, such as metallic form, e.g., metallic copper, metallic iron, metallic cobalt, metallic nickel, and metallic palladium. The metallic forms may be mixtures of particles or alloys. Alternatively, metal salts, including, but not limited to, halide, acetate, nitrate, and carboxylate salts of cobalt, copper, palladium, iron, and nickel, can be mixed in desired proportions and then reduced with hydrogen at elevated temperature, generally greater than 300° C. Examples of metal salts, which are commercially available, include CuCl₂, CuCl, NiCl₂, and PdCl₂.

The at least two different metals can optionally be provided on a support. Examples of supports include activated carbon, silica, and zeolites. In cases where high purity of the product halosilanes are desired, such as for the production of trichlorosilane or silicon tetrachloride for use in manufacturing solar or electronic grade polycrystalline silicon, certain supports should be avoided. Carbon-based supports can form undesirable methane and other carbon by-products under the conditions described. Amorphous silica supports form undesirable siloxane by-products under the conditions described. Alternatively, supports that are highly crystalline and do not generate undesirable by-products in the described process can be used to produce trichlorosilane with high purity. Crystalline silica and certain zeolites, such as Zeolite Y or Zeolite Beta products (e.g., which are commercially available as Zeolyst CBV 780 from Zeolyst International), are example supports that can be used.

The halosilane generally has the formula HₐSiX(₄₋ₐ), where subscript “a” can have an average value of 0 to less than or equal to 3, and each X is independently a halogen atom. Alternatively, subscript a can have an average value of 0 to 3. X may be Cl, Br, F, or I; for example, Cl, Br, or I; and for example, Cl. Examples of halosilanes include chlorosilane (H₃SiCl), dichlorosilane (H₂SiCl₂), trichlorosilane (HSiCl₃), silicon tetrachloride (SiCl₄), and combinations of two or more of H₃SiCl, H₂SiCl₂, HSiCl₃, SiCl₄. Alternatively, subscript “a” can be 0, and the halosilane can be a silicon tetrahalide of formula SiX₄, where X is as described above. Examples of the silicon tetrahalide include, but are not limited, silicon tetrachloride, silicon tetrabromide, silicon tetraiodide, and silicon tetrafluoride. In one embodiment, the silicon tetrahalide is silicon tetrachloride. The halosilane can optionally further comprise a hydrogen source, such as H₂, regardless of the selection of the halosilane.

The hydrogenation can be performed in any reactor for the combining of gases and solids. For example, the reactor configuration can be a packed bed, stirred bed, vibrating bed, moving bed, re-circulating bed, or a fluidized bed. The pressure at which the halosilane is contacted with the catalyst composition can be sub-atmospheric, atmospheric, or super-atmospheric. For example, the pressure can be 0 kilopascals absolute (kPa) to 3,500 kPa, for example, 10 kPa to 2,100 kPa; for example 101 kPa to 2,101 kPa; for example, 101 kPa to 1,101 kPa; for example, 101 kPa to 900 kPa; and for example, 201 kPa to 901 kPa.

When hydrogen is present in the halosilane, the mole ratio of hydrogen to halosilane in the halosilane contacted with the catalyst composition can be 10,000:1 to 0.01:1, for example, 100:1 to 1:1, for example, 20:1 to 5:1, for example, 20:1 to 4:1, for example, 20:1 to 2:1, for example, 20:1 to 1:1, for example, 4:1 to 1:1, and for example, 3:1 to 1.2:1.

The residence time for the halosilane can be long enough for the halosilane to contact the metal combination and hydrogenate the halosilane and can depend on various factors including reactor size and particle size of the metal combination. For example, a sufficient residence time for the ingredient can be at least 0.01 second (s), for example, at least 0.1 s, for example, 0.1 s to 10 minutes (min), for example, 0.1 s to 1 min, for example, 0.5 s to 10 s, for example, 1 min to 3 min, and for example, 5 s to 10 s. Alternatively, the residence time for the catalyst composition to be in contact with the halosilane can be at least 0.1 min; for example, at least 0.5 min; for example, 0.1 min to 120 min; for example, 0.5 min to 9 min; for example, 0.5 min to 6 min. The desired residence time can be achieved by adjusting the flow rate of the H₂ and the halosilane, or by adjusting the total reactor volume, or by any combination thereof.

When hydrogen is present, the H₂ and the halosilane can be fed to the reactor simultaneously; however, other methods of combining, such as by separate pulses, are also envisioned. The H₂ and the halosilane can be mixed together before feeding to the reactor; alternatively, the H₂ and the halosilane can be fed into the reactor as separate streams.

The catalyst composition can be present in an amount sufficient to hydrogenate the halosilane along with the other reactor conditions. As used herein, a “sufficient amount” of catalyst composition is enough to hydrogenate the halosilane, described herein, when the halosilane and optional hydrogen are contacted with the catalyst composition. For example, a sufficient amount of catalyst composition can be at least 0.01 milligrams of metal per cubic centimeter (mg/cm³)mg of reactor volume; for example, at least 0.5 mg metal/cm³ of reactor volume; for example, 1 mg metal/cm³ of reactor volume to maximum bulk density of the metal combination based on the reactor volume, for example, 1 mg to 5,000 mg metal/cm³ of reactor volume, for example, 1 mg to 1,000 mg metal/cm³ of reactor volume, and for example, 1 mg to 900 mg metal/cm³ of reactor volume.

There is no upper limit on the time for which hydrogenation is conducted. For example, hydrogenation can be conducted for at least 0.1 seconds, for example, from 1 second to 5 hours, for example, from 1 minute to 1 hour.

The methods described herein can also include purging the reactor containing the halosilane and the catalyst composition before the halosilane the catalyst composition are contacted. Unwanted materials that may be present are, for example, O₂ and H₂O. Purging may be accomplished with an inert gas, such as argon, nitrogen, or helium or with a reactive gas, such as the halosilane, for example, silicon tetrachloride, which reacts with moisture, thereby removing it. Purging before contacting the halosilane and the catalyst composition can be done to at least partially remove any oxide layer that may be present on a metal in the metal combination. The method can optionally further comprise recovering side products and unreacted ingredients and/or unreacted reactants after hydrogenation of the halosilane. For example, a hydrogen halide, such as HCl, may be produced as a side product after hydrogenation of the halosilane. Hydrogenation of the halosilane with the catalyst composition can also produce an effluent comprising H₃SiCl, H₂SiCl₂, HSiCl₃, SiCl₄, or a combination of two or more of H₃SiCl, H₂SiCl₂, HSiCl₃, SiCl₄. Some or all of these species can be recovered by techniques such as distillation.

The method can further comprise pre-heating and gasifying the halosilane by known methods prior to contacting with the catalyst composition. When hydrogen is used, the method can further comprise bubbling the hydrogen through the halosilane to vaporize the halosilane prior to contacting with the catalyst composition.

The process can further comprise recovering the hydrogenated halosilane produced. The halosilane can be recovered by, for example, removing gaseous halosilane and any other gases from the reactor followed by isolation of the halosilane by distillation.

Examples of halosilanes prepared according to the present method include, but are not limited to, HSiCl₃, HSiBr₃, and HSil₃. The method of the present invention can produce a trihalosilane from a silicon tetrahalide. Since silicon tetrahalide, such as silicon tetrachloride, is a by-product of other industrial processes and may be produced using less energy than required to produce zero-valent silicon, the method of the invention may be more economical than methods of producing trihalosilane using SP.

The method of the present invention produces a trihalosilane that can be used to make high purity polysilicon or that can be hydrolyzed in known processes for producing polysiloxanes. High purity polysilicon finds use in, for example, solar cells and computer chips, and polysiloxanes find use in many industries and applications.

The methods are further illustrated by the following non-limiting examples.

### EXAMPLES

### Example 1

In this example, experiments were conducted at similar operation conditions (e.g., temperature, pressure, etc.) where a composition comprising silicon tetrachloride and hydrogen were contacted with metallurgical grade silicon and catalyst. The catalysts used comprised copper (Cu), a combination of copper and nickel (Cu/Ni), nickel (Ni), and iron (Fe). The results of the experiments are illustrated in FIG. 1, where the absolute silicon tetrachloride conversion increase over a baseline measured in percentages is plotted against the concentration of metal added measured in weight percent. The baseline of silicon tetrachloride conversion was approximately 17%. As can be seen from FIG. 1, the catalyst composition comprising a 50:50 combination of copper and nickel has a higher absolute silicon tetrachloride conversion increase over a baseline. As can also be seen by FIG. 1, the catalyst composition comprising a 50:50 combination of copper and nickel has a higher absolute silicon tetrachloride conversion increase over a baseline as compared to either copper or nickel alone, indicating an unexpected synergistic effect between the copper and nickel that is not observed when using either one alone.

### Example 2

In this example, varying levels of copper and nickel were tested for silicon tetrachloride conversion. The results are illustrated in FIG. 2. The amount of catalyst was measured in weight percent (wt. %) and the amount of silicon tetrachloride converted was measured in percent (%). The catalyst varied from nickel (Ni) to copper (Cu).

As can be seen in FIG. 2, the amount of silicon tetrachloride converted increased with the use of a catalyst containing copper and nickel and had no statistical difference between the amount of silicon tetrachloride converted whether the catalyst composition contained a 50:50 ratio, 25:75 ratio, or 75:25 ratio of copper to nickel.

The methods disclosed herein include at least the following embodiments:

Embodiment 1: A method of hydrogenating a halosilane comprises: contacting a halosilane having the formula HaSiX(4-a), wherein a has a value of 0 to 4, and each X is independently a halogen atom and wherein if a is 0, the halosilane further comprises a hydrogen source, with a catalyst composition comprising at least two different metals, wherein the at least two different metals are selected from Cu and one of Co, Fe, Ni, and Pd; wherein the ratio of Cu to the second metal in the catalyst composition is 90:10 to 10:90; wherein the contacting is conducted at a temperature sufficient to hydrogenate a halosilane; and wherein an increase in the amount of halosilane hydrogenated is observed as compared to a method with a catalyst composition comprising one metal at the same overall loading of metal in the catalyst composition.

Embodiment 2: The method of Embodiment 1, wherein if the hydrogen source is present, the hydrogen source comprises H₂, and a mole ratio of the H₂ to the halosilane is 20:1 to 1:1.

Embodiment 3: The method of Embodiment 1 or Embodiment 2, wherein the halosilane is selected from monochlorosilane, dichlorosilane, trichlorosilane, silicon tetrachloride, or a combination comprising at least one of the foregoing.

Embodiment 4: The method of Embodiment 3, wherein the halosilane is silicon tetrachloride.

Embodiment 5: The method of any of Embodiments 1 to 5, wherein the ratio of Cu to the second metal in the catalyst composition is 75:25 to 25:75.

Embodiment 6: The method of Embodiment 5, wherein the ratio of Cu to the second metal in the catalyst composition is 50:50.

Embodiment 7: The method of any of Embodiments 1 to 6, wherein the catalyst composition comprises Cu and Ni.

Embodiment 8: The method of Embodiment 7, wherein the ratio of Cu to Ni is 75:25 to 25:75.

Embodiment 9: The method of Embodiment 8, wherein the ratio of Cu to Ni is 50:50.

Embodiment 10: The method of any of Embodiments 1 to 6, wherein the catalyst composition comprises Cu and Pd.

Embodiment 11: The method of any of Embodiments 1 to 6 or 10, wherein the ratio of Cu to Pd is 25:75 to 75:25.

Embodiment 12: The method of Embodiment 11, wherein the ratio of Cu to Pd is 50:50.

Embodiment 13: The method of any of Embodiments 1 to 12, wherein the halosilane is hydrogenated into monochlorosilane, dichlorosilane, trichlorosilane, or a combination comprising at least one of the foregoing.

Embodiment 14: The method of Embodiment 13, wherein the halosilane is hydrogenated into trichlorosilane.

Embodiment 15: The method of any of Embodiments 1 to 14, wherein the hydrogenation temperature is 100° C. to 1,200° C.

Embodiment 16: A method of hydrogenating silicon tetrachloride comprises: contacting silicon tetrachloride with a catalyst composition comprising at least two different metals selected from Cu, Co, Fe, Ni, and Pd; wherein the ratio of the two metals is 75:25 to 25:75; wherein the contacting is conducted at a temperature sufficient to hydrogenate the silicon tetrachloride; and wherein an increase in the amount of silicon tetrachloride hydrogenated is observed as compared to a method with a catalyst composition comprising one metal at the same overall loading of metal in the catalyst composition.

Embodiment 17: The method of Embodiment 16, wherein the hydrogenation temperature is 100° C. to 1,200° C.

Embodiment 18: The method of Embodiment 16 or Embodiment 17, wherein the catalyst composition comprises a combination of Cu and Ni or a combination of Cu and Pd.

Embodiment 19: The method of Embodiment 18, wherein the ratio of Cu to Ni or the ratio of Cu to Pd is 50:50.

Embodiment 20: The method of any of Embodiments 16-19, wherein the silicon tetrachloride is hydrogenated into trichlorosilane.

For purposes of this application, the term “silicon alloy” means a material of empirical formula Co_{c}Cu_{d}FeₑNi_{f}Pd_{g}Siₕ, where subscripts c, d, e, f, g, and h represent the molar amounts of each element present, and c≥0, d≥0, e≥0, f≥0, g≥0, and h≥1; with the provisos that at least two of c, d, e, f, and g are not 0, and at least one of c, d, and e is not 0.

Metallic” means that the metal has an oxidation number of zero.

“Purging” means to introduce a gas stream into a container to remove unwanted materials.

“Treating” means to introduce a gas stream into a container to pre-treat a component before contacting the component with another component. Treating includes contacting the silicon, and/or the two or more different metals, to reduce or otherwise activate them before contacting with the ingredient comprising the halosilane in step (1) of the method and/or before step (2) of the method.

“Residence time” means the time which a component takes to pass through a reactor system in a continuous process, or the time a component spends in the reactor in a batch process. For example, residence time in step (1) refers to the time during which one reactor volume of the silicon alloy catalyst makes contact with the ingredient comprising the halosilane as the silicon alloy catalyst passes through the reactor system in a continuous process or during which the silicon alloy catalyst is placed within the reactor in a batch process. Alternatively, residence time may refer to the time for one reactor volume of reactive gases to pass through a reactor charged with the silicon alloy catalyst in step (1). (E.g., residence time includes the time for one reactor volume of and the ingredient comprising the halosilane in step (1) to pass through a reactor charged with the silicon alloy catalyst or the time for one reactor volume of halosilane to pass through a reactor charged with the reactant in step (2) of the method described herein.)

“Silicon alloy catalyst” means a solid product that is formed in step (1) of the method described herein, and/or re-formed in step (3) of the method described herein.

“Spent catalyst” refers to the silicon alloy catalyst after step (2) (and after step (4), when step (4) is present). The spent catalyst after step (2) (or step (4)) contains an amount of silicon that is less than the amount of silicon in the silicon alloy catalyst after step (1) and before beginning step (2) (or after step (3) and before beginning step (4)). Spent catalyst may, or may not, be exhausted, i.e., spent catalyst may contain some silicon that may or may not be reactive.

The singular forms “a,” “an,” and “the” include plural referents unless the context clearly dictates otherwise. “Or” means “and/or.” The modifier “about” used in connection with a quantity is inclusive of the stated value and has the meaning dictated by the context (e.g., includes the degree of error associated with measurement of the particular quantity). The notation “±10%” means that the indicated measurement can be from an amount that is minus 10% to an amount that is plus 10% of the stated value. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group.

The suffix “(5)” is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs. A “combination” is inclusive of blends, mixtures, alloys, reaction products, and the like.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

I/we claim:

1. A method of hydrogenating a halo silane, comprising:
contacting a halosilane having the formula HaSiX(4-a), wherein a has a value of 0 to 4, and each X is independently a halogen atom and wherein if a is 0, the halosilane further comprises a hydrogen source, with a catalyst composition comprising at least two different metals, wherein the at least two different metals are selected from Cu and one of Co, Fe, Ni, and Pd;
wherein the ratio of Cu to the second metal in the catalyst composition is 90:10 to 10:90;
wherein the contacting is conducted at a temperature sufficient to hydrogenate a halosilane; and
wherein an increase in the amount of halosilane hydrogenated is observed as compared to a method with a catalyst composition comprising one metal at the same overall loading of metal in the catalyst composition.

2. The method of claim 1, wherein if the hydrogen source is present, the hydrogen source comprises H₂, and a mole ratio of the H₂ to the halosilane is 20:1 to 1:1.

3. The method of claim 1, wherein the halosilane is selected from monochlorosilane, dichlorosilane, trichlorosilane, silicon tetrachloride, or a combination comprising at least one of the foregoing.

4. The method of claim 3, wherein the halosilane is silicon tetrachloride.

5. The method of claim 1, wherein the ratio of Cu to the second metal in the catalyst composition is 75:25 to 25:75.

6. The method of claim 1, wherein the catalyst composition comprises Cu and Ni.

7. The method of claim 1, wherein the catalyst composition comprises Cu and Pd.

8. The method of claim 1, wherein the halosilane is hydrogenated into monochlorosilane, dichlorosilane, trichlorosilane, silicon tetrachloride, or a combination comprising at least one of the foregoing.

9. The method of claim 8, wherein the halosilane is hydrogenated into trichlorosilane.

10. The method of claim 1, wherein the hydrogenation temperature is 100° C. to 1,200° C.

11. A method of hydrogenating silicon tetrachloride, comprising:
contacting silicon tetrachloride with a catalyst composition comprising at least two different metals selected from Cu, Co, Fe, Ni, and Pd;
wherein the ratio of the two metals is 75:25 to 25:75;
wherein the contacting is conducted at a temperature sufficient to hydrogenate the silicon tetrachloride; and
wherein an increase in the amount of silicon tetrachloride hydrogenated is observed as compared to a method with a catalyst composition comprising one metal at the same overall loading of metal in the catalyst composition.

12. The method of claim 11, wherein the hydrogenation temperature is 100° C. to 1,200° C.

13. The method of claim 11, wherein the catalyst composition comprises a combination of Cu and Ni or a combination of Cu and Pd.

14. The method of claim 13, wherein the ratio of Cu to Ni or the ratio of Cu to Pd is 50:50.

15. The method of claim 11, wherein the silicon tetrachloride is hydrogenated into trichlorosilane.

16. The method of claim 5, wherein the ratio of Cu to the second metal in the catalyst composition is 50:50.

17. The method of claim 6, wherein the ratio of Cu to Ni is 75:25 to 25:75.

18. The method of claim 7, wherein the ratio of Cu to Pd is 25:75 to 75:25.
